(19) United States
(12) Patent Application Publication
(10) Pub. No.: US 2022/0407544 A1
(43) Pub. Date: Dec. 22, 2022

(54) RADIO COMMUNICATION CIRCUIT WITH RADIO FREQUENCY QUADRATURE GENERATION

(71) Applicant: Intel Corporation, Santa Clara, CA (US)

(72) Inventors: Woorim SHIN, Portland, OR (US); Ritesh A. BHAT, Hillsboro, OR (US); Chuanzhao YU, Phoenix, AZ (US); Stefano PELLERANO, Beaverton, OR (US)

(21) Appl. No.: 17/353,840

(22) Filed: Jun. 22, 2021

(51) Int. Cl. H04B 1/04; H04B 1/30; H01Q 21/24

(52) U.S. Cl. CPC H04B 1/04; H04B 1/30; H01Q 21/24; H04B 2001/0408; H04B 2001/307

(57) ABSTRACT

Radio communication circuits, radio transmitters, and methods are provided in this disclosure. The radio communication circuit may include a modulator configured to provide a first modulated signal including a carrier signal at a carrier frequency, and a second modulated signal including the carrier signal at the carrier frequency. The radio communication circuit may further include a phase shift generator configured to receive a first signal based on the first modulated signal and a second signal based on the second modulated signal. The phase shift generator of the radio communication circuit may further be configured to provide a predefined phase difference between the first signal and the second signal.

### TECHNICAL FIELD

Various aspects of this disclosure generally relate to a radio communication circuit, a radio transmitter, and a method.

### BACKGROUND

Communication devices transmit and receive communication signals to exchange information. Various modulation methods are used to implement an information-bearing signal on a carrier signal which is suitable to carry information in a communication medium so that information can be transferred in the communication medium via the carrier signal. For that purpose, a transmitter may include a modulator to impress the carrier signal based on the information-bearing signal so that a receiver may retrieve the conveyed information by demodulating the received signal and obtaining an indication regarding the conveyed information.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows schematically a block diagram of an example of a radio communication device;

FIG. 2 shows schematically a block diagram of an example radio frequency (RF) front end;

FIG. 3 shows schematically an example of a radio communication circuit;

FIG. 4 shows schematically a block diagram of an exemplary radio communication device or system;

FIG. 5 shows schematically an example of a radio communication circuit;

FIG. 6 shows schematically an example of a radio communication circuit;

FIG. 7 shows schematically an example of a radio communication circuit;

FIG. 8 shows schematically an example of a radio communication circuit;

FIG. 9 shows schematically an example of a radio communication circuit;

FIG. 10 shows schematically an example of a method.

### DESCRIPTION

The following detailed description refers to the accompanying drawings that show, by way of illustration, exemplary details and aspects in which aspects of the present disclosure may be practiced.

With the recent implementation of communication techniques to support increases in data traffic, radio communication devices need to support channels at higher frequencies with wider bandwidths (BW) and higher-order modulations schemes. Traditionally, modulation may be performed by changing at least one feature of a carrier signal based on the information to be transmitted, such as amplitude, frequency, phase of the carrier signal, or their combinations. As the recent developments tend to adopt the use of the spectrum that is suitable for communicating at higher frequencies to support the use of more channels in the spectrum, and also to increase the bandwidth, the increased frequency of carrier signals has introduced certain challenges to the traditional techniques.

Furthermore, due to the advancement in communication technologies, e.g. wireless communication technology, and also semiconductor technology, and the motivation to provide devices having smaller form factor to the market, smaller radio communication devices may be provided for various reasons.

Carrier signals that are used in radio communication include sinusoidal signals which may be represented as A*cos(2πft+φ(t)) in polar coordinates. Mathematically, this representation may be modeled as the combination of two modulated sinusoids that are offset in phase by 90 degrees. In-phase and quadrature components may be used to represent these two modulated sinusoids.

One of the methods that are commonly used to modulate radio communication signals includes using baseband signals that are provided as vectors, namely as an in-phase component and a quadrature component as information-bearing signals, and providing modulation to the carrier signal according to the provided in-phase components and quadrature components.

The conventional techniques of modulation include using multiple local oscillators, or active quadrature local oscillation generation techniques that may have increased power consumption and expensive. Furthermore, maintaining magnitude balance and phase balance between in-phase and quadrature local oscillator signals along multiple stages of local oscillator buffers may be challenging with the increased frequency. Furthermore, parallel quadrature routing may impose further challenges in terms of design, layout floor plan, and calibration methodologies. Furthermore, the adaptation of phased array systems using local oscillator phase shifting or baseband phase-shifting techniques may require the distribution of local oscillators over multiple receiver elements. Various aspects of this disclosure are provided to overcome at least some of the challenges defined herein.

The following detailed description refers to the accompanying drawings that show, by way of illustration, specific details and aspects in which the disclosure may be practiced.

The word “exemplary” is used herein to mean “serving as an example, instance, or illustration”. Any aspect or design described herein as “exemplary” is not necessarily to be construed as preferred or advantageous over other aspects or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one. The terms “proper subset”, “reduced subset”, and “lesser subset” refer to a subset of a set that is not equal to the set, i.e. a subset of a set that contains fewer elements than the set.

The term “amplifier” utilized herein refers to any type of component, circuit, module, or device which amplifies (i.e. increase power/amplitude) an input signal and may provide an amplified signal as an output signal. The amplifier may be any type of amplifier, an amplifier stack, or an amplifier stage.

As used herein, “memory” is understood as a non-transitory computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

The term “radio communication device” utilized herein refers to any devices using radio frequency signals for communication including user-side devices (both portable and fixed) that can connect to a core network and/or external data networks via a radio access network. “Radio communication device” can include any mobile or immobile wireless communication device, including User Equipment (UEs), Mobile Stations (MSs), Stations (STAs), cellular phones, tablets, laptops, personal computers, wearables, multimedia playback, and other handheld or body-mounted electronic devices, consumer/home/office/commercial appliances, vehicles, and any other electronic device capable of user-side wireless communications. Without loss of generality, in some cases terminal devices can also include application-layer components, such as application processors or other general processing components that are directed to functionality other than wireless communications. Radio communication devices can optionally support wired communications in addition to wireless communications. Furthermore, radio communication devices can include vehicular communication devices that function as radio communication devices. The term “radio communication circuit” may refer to a circuit of a radio communication device.

Various aspects of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. As used herein, a first radio communication technology may be different from a second radio communication technology if the first and second radio communication technologies are based on different communication standards.

Aspects described herein may use such radio communication technologies according to various spectrum management schemes, including, but not limited to, dedicated licensed spectrum, unlicensed spectrum, (licensed) shared spectrum (such as LSA, “Licensed Shared Access,” in 2.3-2.4 GHz, 3.4-3.6 GHz, 3.6-3.8 GHz and further frequencies and SAS, “Spectrum Access System,” in 3.55-3.7 GHz and further frequencies), and may be use various spectrum bands including, but not limited to, IMT (International Mobile Telecommunications) spectrum (including 450-470 MHz, 790-960 MHz, 1710-2025 MHz, 2110-2200 MHz, 2300-2400 MHz, 2500-2690 MHz, 698-790 MHz, 610-790 MHz, 3400-3600 MHz, etc., where some bands may be limited to specific region(s) and/or countries), IMT-advanced spectrum, IMT-2020 spectrum (expected to include 3600-3800 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 64-71 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), the 70.2 GHz-71 GHz band, any band between 65.88 GHz and 71 GHz, bands currently allocated to automotive radar applications such as 76-81 GHz, and future bands including 94-300 GHz and above.

For purposes of this disclosure, radio communication technologies may be classified as one of a Short-Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (GSM), Code Division Multiple Access 2000 (CDMA2000), Universal Mobile Telecommunications System (UMTS), Long Term Evolution (LTE), General Packet Radio Service (GPRS), Evolution-Data Optimized (EV-DO), Enhanced Data Rates for GSM Evolution (EDGE), High Speed Packet Access (HSPA; including High Speed Downlink Packet Access (HSDPA), High Speed Uplink Packet Access (HSUPA), HSDPA Plus (HSDPA+), and HSUPA Plus (HSUPA+)), Worldwide Interoperability for Microwave Access (WiMax) (e.g., according to an IEEE 802.16 radio communication standard, e.g., WiMax fixed or WiMax mobile), etc., and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

The terms “radio communication network,” “wireless network”, “communication network,” or the like, as utilized herein encompasses both an access section of a network (e.g., a radio access network (RAN) section) and a core section of a network (e.g., a core network section).

Unless explicitly specified, the term “transmit” encompasses both direct (point-to-point) and indirect transmission (via one or more intermediary points). Similarly, the term “receive” encompasses both direct and indirect reception. Furthermore, the terms “transmit”, “receive”, “communicate”, and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as radio frequency (RF) transceivers and antennas, and the logical transmission and reception over the software-level connection is performed by the processors or controllers. The term “communicate” may encompass one or both of transmitting and receiving, i.e., unidirectional or bidirectional communication in one or both of the incoming and outgoing directions. The term “calculate” may encompass both ‘direct’ calculations via a mathematical expression/formula/relationship and ‘indirect’ calculations via lookup or hash tables and other array indexing or searching operations.

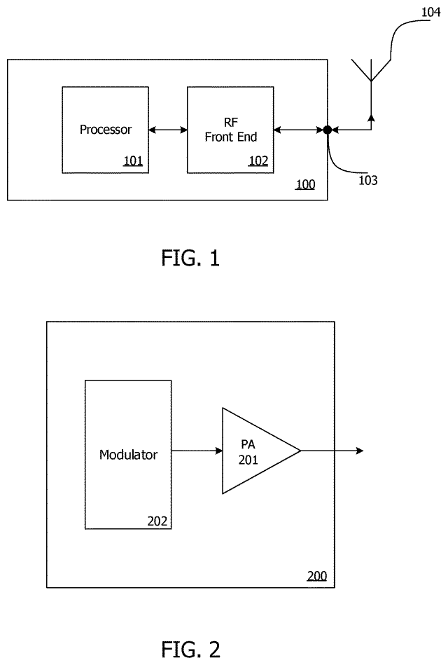

FIG. 1 shows schematically a block diagram of an example of a radio communication device 100. The radio communication device 100 includes a processor 101. A radio frequency (RF) front end 102 is coupled to the processor 101 and an antenna port 103. The antenna port 103 may be coupled to an antenna 104. The communication device 100 may include a plurality of processors, a plurality of radio frequency (RF) front ends, a plurality of antenna ports, and a plurality of antennas.

For transmitting function, the processor 101 provides signals to be transmitted to the radio frequency (RF) front end 102. The radio frequency (RF) front end 102 may receive the signals from the processor 101. The radio frequency (RF) front end 102 provides the radio frequency (RF) communication signals to the antenna port 103 so that the antenna 104 receives the radio frequency (RF) communication signals from the antenna port 103 and transmits the radio communication signals. The radio frequency (RF) front end 102 may include an upconverter to convert received signals to the radio frequency (RF) communication signals. The radio frequency (RF) front end 102 may include a power amplifier.

For receiving function, the antenna port 103 receives radio frequency (RF) communication signals from the antenna 104. The radio frequency (RF) front end 102 receives the radio frequency (RF) communication signals from the antenna port 103. The radio frequency (RF) front end may 102 include a downconverter to convert the radio frequency (RF) communication signals. The radio frequency (RF) front end 102 provides its output to the processor 101 which may receive baseband communication signals and decode the baseband communication signals.

The radio communication device 100 is only provided as an example of a radio communication device capable of performing both a transmitting function and a receiving function. A radio communication device may exemplarily be capable of performing only one of these functions (i.e. as a receiver or transmitter), and various aspects provided with this disclosure may apply in these examples as well.

The radio communication device 100 may communicate with a radio communication network, or other radio communication devices and/or network access nodes. Although the communication may take place in compliant with certain examples described herein which refer to a particular radio access network context (e.g., WLAN/WiFi, 5G, NR, LTE, or other 3rd Generation Partnership Project (3GPP) networks, Bluetooth, mmWave, etc.), these examples are demonstrative and may therefore be readily applied to any other type or configuration of radio access network.

FIG. 2 shows schematically a block diagram of an example radio frequency (RF) front end 200 that may be implemented in a radio communication device including a transmitter. A transmit signal path (Tx path) of the radio frequency (RF) front end 200 includes a PA (power amplifier) 201 to amplify input radio frequency (RF) signals. The radio frequency (RF) front end may also include a modulator 202 to modulate an information-bearing signal with a carrier signal to provide the modulated signal to the power amplifier 201 for transmission. The power amplifier 201 may receive the modulated signal, and amplify the modulated signal and provide an amplified output signal to an antenna port, or an antenna. Alternatively, the power amplifier 201 may provide the amplified output signal to further blocks, such as a filter, a matching circuit, etc.

The radio frequency (RF) front end 200 may be coupled to a processor which may include a baseband processor, to receive a baseband signal as the information-bearing signal. The radio frequency (RF) front end 200 may be coupled to a digital front end configured to receive information to be transmitted and provide the information-bearing signals to the radio frequency (RF) front end. The radio frequency (RF) front end 200 may be coupled to another modulator that is configured to provide the information-bearing signal at an intermediate frequency.

Furthermore, the radio frequency (RF) front end 200 may also include a receive signal path (Rx). The receive signal path may include a demodulator to demodulate a communication signal, and a low-noise amplifier, coupled to the antenna port or antenna to receive the communication signal. The receive signal path may be configured to provide a demodulated signal to the processor or to further circuits or blocks.

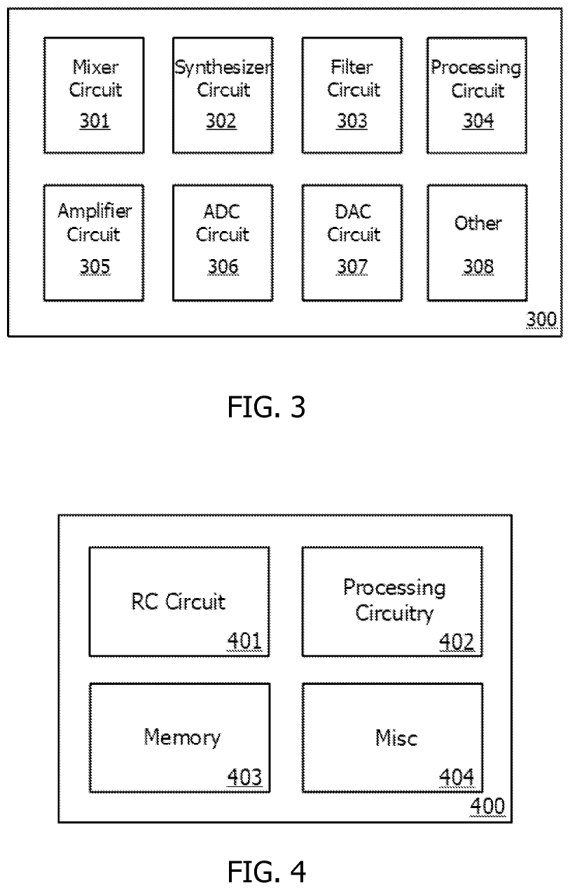

FIG. 3 shows schematically an example of a radio communication circuit 300 which a radio communication device may include. The radio communication circuit 300 can include components such as a mixer circuit 301, a synthesizer circuit 302 (e.g., local oscillator), a filter circuit 303 (e.g., baseband filter), a processing circuit 304, an amplifier circuit 305, an analog-to-digital converter (ADC) circuit 306, a digital-to-analog (DAC) circuit 307, and other suitable digital front end (DFE) components 308, to name a few. The processing circuit 304 may include a processor, which in turn may include a time-domain and/or frequency domain processor(s)/components in at least one example.

Accordingly, the exemplary radio frequency (RF) front end 200 referred with respect to FIG. 2 may be provided by a combination of the circuits provided with respect to the schematic representation of the example of the radio communication circuit 300. It should be noted that any of these circuits may include a plurality of circuits configured to provide the functionality. For example, the amplifier circuit 305 may include a plurality of amplifier circuits or amplifiers.

The other components 308 may include logic components, modulation/demodulation elements, and an interface circuit for interfacing with another component, e.g., an SoC, or a modem. Digital front end components may include any suitable number and/or type of components configured to perform functions known to be associated with digital front ends.

The digital front end may include digital processing circuit, portions of processing circuitry, one or more portions of an on-board chip having dedicated digital front end functionality (e.g., a digital signal processor), etc. The digital front end components may selectively perform specific functions based upon the operating mode of the radio communication circuit 300. The digital front end components may facilitate beamforming.

Digital front end components may also include other components associated with data transmission such as, for instance, transmitter impairment correction such as LO correction, DC offset correction, IQ imbalance correction, and ADC skew, digital pre-distortion (DPD) calculation, correction factor (CF) calculation, and pre-emphasis (pre. emp.) calculation. To provide additional examples, the digital front end components may facilitate or perform receiver or transmitter digital gain control (DGC), up-sampling, down-sampling, zero crossing detection algorithms, phase modulation, perform beam management, digital blocker cancellation, received signal strength indicator (RSSI) measurements, DPD and calibration accelerators, test signal generation, etc.

The radio communication circuit 300 may include a receive signal path which may include the mixer circuit 301, the amplifier circuit 305, and the filter circuit 303. The transmit signal path of the radio communication circuit 300 may include the filter circuit 303, the amplifier circuit 305, and the mixer circuit 301. The radio communication circuit may also include the synthesizer circuit 302 to synthesize a frequency signal for use by the mixer circuit 301 of the receive signal path and the transmit signal path. The mixer circuit 301 of the receive signal path may be configured to down-convert radio frequency (RF) signals received based on the synthesized frequency provided by synthesizer circuit 302.

The output baseband signals and the input baseband signals may be digital baseband signals. The radio communication circuit 300 may include the analog-to-digital converter (ADC) circuit 306 and the digital-to-analog converter (DAC) circuit 307.

The radio communication circuit 300 may also include a transmit signal path (Tx path) which may include a circuit to up-convert baseband signals provided by a modem and provide radio frequency (RF) output signals for transmission. The receive signal path of the radio communication circuit 300 may include the mixer circuit 301, the amplifier circuit 305, and the filter circuit 303. The transmit signal path of the radio communication circuit 300 may include the filter circuit 303, the amplifier circuit 305, and the mixer circuit 301. The radio communication circuit 300 may include synthesizer circuit 302 to synthesize a frequency signal for use by the mixer circuit 301 of the receive signal path and the transmit signal path. The mixer circuit 301 of the receive signal path may be configured to received down-convert radio frequency (RF) signals based on the synthesized frequency provided by synthesizer circuit 302.

Amplifier circuit 305 may be configured to amplify the down-converted signals, and filter circuit 303 may be a low-pass filter (LPF) or band-pass filter (BPF) configured to remove unwanted signals from the down-converted signals to generate output baseband signals. Output baseband signals may be provided to another component, e.g., a modem, for further processing. The output baseband signals may be zero-frequency baseband signals, although this is not a requirement.

The mixer circuit 301 for a receive signal path may include passive mixers, although the scope of this disclosure is not limited in this respect. The mixer circuit 301 for a transmit signal path may be configured to up-convert input baseband signals based on the synthesized frequency provided by the synthesizer circuit 302 to generate radio frequency (RF) output signals. Amplifier circuit 305 may be configured to amplify the radio frequency (RF) output signals, and filter circuit 303 may be a low-pass filter (LPF) or band-pass filter (BPF) configured to remove unwanted signals from the up-converted signals to provide communication signals to be transmitted. The radio frequency (RF) communication signals may be provided to another component, to an antenna port or an antenna.

The mixer circuit 301 of the receive signal path and the mixer circuit 301 of the transmit signal path may include two or more mixers and may be arranged for quadrature down conversion and up conversion, respectively. The mixer circuit 301 of the receive signal path and the mixer circuit 301 of the transmit signal path may include two or more mixers and may be arranged for image rejection (e.g., Hartley image rejection). The mixer circuit 301 of the receive signal path and the mixer circuit 301 may be arranged for direct down conversion and direct up conversion, respectively. The mixer circuit 301 of the receive signal path and the mixer circuit 301 of the transmit signal path may be configured for super-heterodyne operation.

In some dual-mode aspects, a separate radio IC circuit may be provided for processing signals for each spectrum, although the scope of this disclosure is not limited in this respect.

The synthesizer circuit 302 may be a fractional-N synthesizer or a fractional N/N+1 synthesizer, although the scope of this disclosure is not limited in this respect as other types of frequency synthesizers may be suitable. For example, synthesizer circuit 302 may be a delta-sigma synthesizer, a frequency multiplier, or a synthesizer including a phase-locked loop with a frequency divider.

The synthesizer circuit 302 may be configured to synthesize an output frequency for use by the mixer circuit 301 of the radio communication circuit 300 based on a frequency input and a divider control input. The synthesizer circuit 302 may be a fractional N/N+1 synthesizer.

Frequency input may be provided by a voltage-controlled oscillator (VCO), although that is not a requirement. Divider control input may be provided by a processing component of the radio communication circuit 300 or may be provided by any suitable component, such as an external component like a modem. For example, the modem may provide a divider control input depending on the desired output frequency. A divider control input (e.g., N) may be determined from a look-up table based on a channel indicated by an external component.

Synthesizer circuit 302 of the radio communication circuit 300 may include a divider, a delay-locked loop (DLL), a multiplexer, and a phase accumulator. The divider may be a dual modulus divider (DMD) and the phase accumulator may be a digital phase accumulator (DPA). The DMD may be configured to divide the input signal by either N or N+1 (e.g., based on a carry out) to provide a fractional division ratio. The DLL may include a set of cascaded, tunable, delay elements, a phase detector, a charge pump, and a D-type flip-flop. The delay elements may be configured to break a VCO period up into No equal packets of phase, where Nd is the number of delay elements in the delay line. In this way, the DLL provides negative feedback to help ensure that the total delay through the delay line is one VCO cycle.

Synthesizer circuit 302 may be configured to generate a carrier frequency as the output frequency. The output frequency may be a multiple of the carrier frequency (e.g., twice the carrier frequency, four times the carrier frequency) and used in conjunction with quadrature generator and divider circuit to generate multiple signals at the carrier frequency with multiple different phases with respect to each other. The output frequency may be a LO frequency (fLO). The radio communication circuit 300 may include an IQ/polar converter.

While the radio communication circuit 300 described herein includes traditional super-heterodyning schemes or architectures, other types of transceiver or transmitter architectures and schemes may be used. The radio communication circuit 300 may include components to implement a near zero IF scheme, a Direct Conversion scheme, or a digital transmission scheme, such as, for example, a Digital IQ transmission, a Digital Polar transmission, and the like.

The radio communication circuit 300 may include a transmit path that includes or implements a direct digital transmitter (DDT). That is, a DDT may include a digital signal processor, an RF digital-to-analog converter (RFDAC), an RF filter/antenna coupler. Further, a DDT may be implemented with or without an IQ-mixer. In general, an RF-DAC may be included on an RFIC to convert digital input into an RF signal. A DDT may include other digital components such as numerically controlled oscillator (NCO) and digital mixers for shifting an input signal to the desired frequency.

The use of a DDT can reduce the number of analog components needed in the transmitter or transmit path. For example, analog LOs, analog filters, analog mixers, and etc., may be eliminated from the RFIC when a direct digital transmitter such as DDT is employed. Further, the use of a digital transmitter or digital transmission schemes may bring energy savings and efficiencies.

FIG. 4 illustrates schematically a block diagram of an exemplary radio communication device 400 or system. The components of the radio communication device 400 are provided for ease of explanation, and in other cases, the radio communication device 400 can include additional, less, or alternative components as those shown in FIG. 4.

As shown in FIG. 4, the radio communication device 400 can include a radio communication circuit 401, exemplarily the radio communication circuit provided with respect to FIG. 3, a processing circuit 402, a memory 403. The radio communication device 400 may include miscellaneous components, modules, or portions 404 as well. The radio communication device 400 may include a modem or SoC. The radio communication device 400 may include one or more power sources, display interfaces, peripheral devices, ports (e.g., input, output), etc.

The radio communication device 400 may be used for products involving 5G, Wifi, BT, UWB, or any suitable wireless network products. The radio communication device 400 may also be used for any device supporting data-intensive applications, including streaming video (e.g., 4K, 8K video) or augmented/virtual reality (AR/VR) devices. The radio communication device 400 may also be used for vehicles, e.g., to help support a self-driving car and/or to be used as vehicle network. The radio communication device 400 may be used for Vehicle-to-everything (V2X) which includes vehicle-to-vehicle (V2V) and vehicle-to-infrastructure (V2I).

The processing circuit 402 may include any suitable number and/or type of computer processors, such as, for facilitating control of the radio communication device 400. In some cases, the processing circuit 402 may include a baseband processor (or suitable portions thereof) implemented by the radio communication device 400. In other cases, the processing circuit 402 may be one or more processors that are separate from the baseband processor (e.g., one or more digital signal processors). The processing circuit 402 may be working together with a processing circuit of the radio communication circuit 401. The processing circuit 402 may include a processing circuit of the radio communication circuit 401. Additionally, or alternatively, other examples may include various functions discussed herein by the processing circuit 402.

The processing circuit 402 may be configured to carry out instructions to perform arithmetical, logical, and/or input/output (I/O) operations, and/or to control the operation of one or more components of the radio communication device 400. For example, the processing circuit 402 can include one or more microprocessors, memory registers, buffers, clocks, etc. Moreover, aspects include processing circuit 402 communicating with and/or controlling functions associated with the memory 403 and/or functions of the radio.

The memory 403 may store data and/or instructions such that, when the instructions are executed by the processing circuit 402, the processing circuit 402 performs the various functions described herein. The memory 403 may be implemented as a non-transitory computer-readable medium storing one or more executable instructions such as, for example, logic, algorithms, code, etc. Instructions, logic, code, etc., stored in the memory 403 may enable the aspects disclosed herein to be functionally realized.

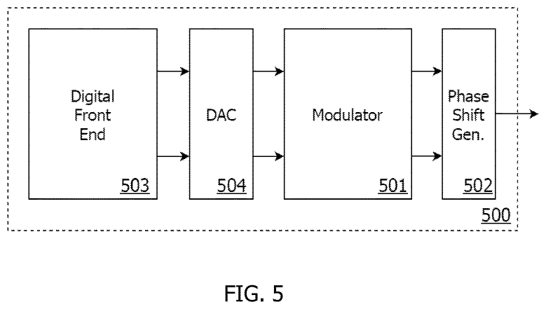

FIG. 5 shows schematically an example of a radio communication circuit. The radio communication circuit 500 includes a modulator 501, and a phase shift generator 502. The radio communication circuit 500 may include a digital front end 503, and a digital to analog converter 504 configured to provide a first baseband signal and a second baseband signal to the modulator 501. The first baseband signal may include an in-phase component and the second baseband signal may include a quadrature component. The modulator 501 may be configured to provide a first modulated signal based on the first baseband signal, and a second modulated signal based on the second baseband signal.

The modulator 501 modulates input signals with a carrier frequency. The modulator 501 may modulate the first baseband signal with a carrier frequency, and the modulator 501 may modulate the second baseband signal with the same carrier frequency. Accordingly, the modulator 501 may modulate the first baseband signal with a carrier frequency to provide a first modulated signal. The modulator 501 may also provide the second baseband signal with the same carrier frequency to provide a second modulated signal. Accordingly, the first modulated signal and the second modulated signal may include the same carrier signal. In other words, there would be no phase difference introduced by the modulator 501, and the modulator 501 may provide the first modulated signal and the second modulated signal without a phase difference. The modulator 501 may be any type of modulator to modulate the signal with a carrier frequency.

The modulator 501 may be coupled to the phase shift generator 502. There may be other blocks coupled between the modulator 501 and the phase shift generator 502. The phase shift generator 502 may receive the first signal based on the first modulated signal and the second signal based on the second modulated signal. The first signal may include the first modulated signal, and the second signal may include the second modulated signal.

The phase shift generator 502 may further be configured to provide a predefined phase difference between the first signal and the second signal. The phase shift generator 502 may provide a predefined phase difference of 90 degrees between the first signal and the second signal to perform a quadrature modulation.

The phase shift generator 502 may include a delay circuit to provide the predefined phase difference. The phase shift generator 502 may include a quadrature generator to provide the predefined phase difference. The quadrature generator may include structures such as branch-line coupler, and/or a quadrature coupler, and/or a hybrid coupler that is configured to provide the predefined phase difference. The phase shift generator 502 may provide the predefined phase difference between the first signal and the second signal to obtain a first output signal based on the first signal, and a second output signal based on the second signal. The phase shift generator 502 may combine the first output signal and the second output signal to obtain a combined output signal.

The phase shift generator 502 may be coupled to a power amplifier, and the phase shift generator 502 may provide the combined output signal to the power amplifier. The power amplifier may amplify the combined output signal and provide the amplified output signal to an antenna port or an antenna for transmission, such that the antenna may transmit the amplified output signal.

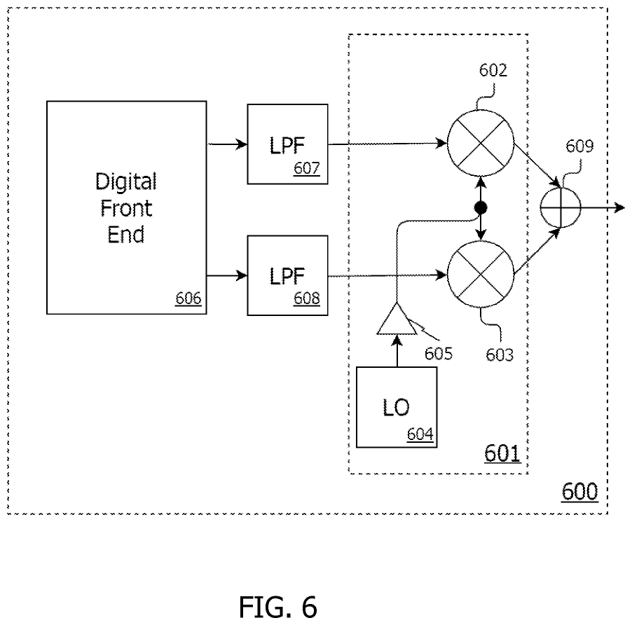

FIG. 6 shows schematically an example of a radio communication circuit. The radio communication circuit 600 may include a modulator 601. The modulator 601 may include a first mixer 602, a second mixer 603, a local oscillator 604 that may include a voltage controlled oscillator, and a buffer 605. A processor may control the local oscillator 604 to generate a carrier signal.

The carrier signal may be a sinusoidal signal having a predetermined amplitude and a predetermined frequency. The local oscillator 604 may provide the generated carrier signal to the buffer 605 to isolate and drive the first mixer 602 and the second mixer 603 from the local oscillator 604. The buffer 605 may provide two carrier signals to the first mixer 602 and the second mixer 603. Accordingly, the first mixer 602 and the second mixer 603 may receive the same carrier signal. Alternatively, the first mixer 602 and the second mixer 603 may receive a first carrier signal, and a second carrier signal, and the first carrier signal and the second carrier signal may be in phase (i.e. the phase difference may be 0).

The modulator 601 may receive a first baseband signal and a second baseband signal. The modulator 601 may be coupled to a digital front end 606, or a processor including a baseband processor, to receive the first baseband signal and the second baseband signal. There may be low pass filters 607, 608 coupled between the modulator 601 and the digital front end 606 to filter the first baseband signal and the second baseband signal. The first baseband signal may include an in-phase component. The second baseband signal may include a quadrature component.

The first mixer 602 may receive the first baseband signal, and the first mixer 602 may modulate the first baseband signal with the carrier signal which the first mixer 602 receives to provide a first modulated signal. The second mixer 603 may receive the second baseband signal, and the second mixer 603 may modulate the second baseband signal with the carrier signal which the second mixer 603 receives to provide a second modulated signal. The first mixer 602 and the second mixer 603 perform the modulation using the carrier signals in phase, thus the phase difference between the first modulated signal and the second modulated signal may be zero. In other words, the first modulated signal and the second modulated signal may be in phase.

The radio communication circuit 600 may further include a phase shift generator 609 to provide a phase difference between the first modulated signal and the second modulated signal. The phase shift generator 609 may receive the first modulated signal as a first signal and the second modulated signal as a second signal and provide a predetermined phase difference between the first modulated signal and the second modulated signal. The first modulated signal and the second modulated signal may be in phase, and the phase shift generator 609 may provide a predetermined phase difference of 90 degrees between the first modulated signal and the second modulated signal.

For example, the phase shift generator 609 may include a quadrature generator, such as a quadrature coupler, or a branch-line coupler, or a 90-degree hybrid. When the quadrature generator includes a branch-line coupler, the quadrature generator may include a set of quarter wavelength transmission lines. When the quadrature generator includes a 90-degree hybrid, the quadrature generator may include lumped inductors.

The phase shift generator 609 may be coupled to an output of the first mixer 602 and an output of the second mixer 603 to receive the first modulated signal and the second modulated signal respectively. The phase-shift generator 609 may provide a predetermined phase difference of 90 degrees between the first signal and the second signal. The phase shift generator 609 may also combine the first signal and the second signal to provide an output signal, and the output signal may include a combination of the first signal and the second signal.

For example, the first signal may include the first baseband signal including the in-phase component, and the second signal may include the second baseband signal including the quadrature component, and the quadrature generator may introduce a phase shift of 90 degrees to the second signal. Accordingly, the output signal may include the first signal and the second signal having a phase shift of 90 degrees relative to the first signal.

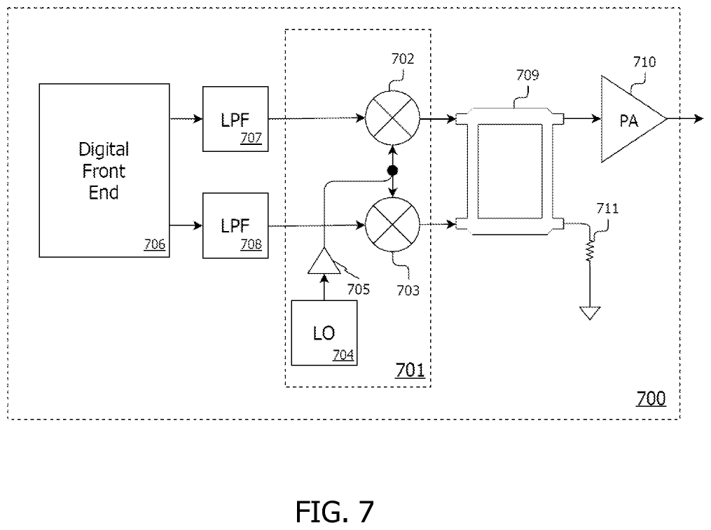

FIG. 7 shows schematically an example of a radio communication circuit. Aspects that are provided in accordance with FIG. 6 in this disclosure may also apply to FIG. 7, e.g. in relation to the radio communication circuit 700. The radio communication circuit 700 may include a modulator 701. The modulator 701 may include a first mixer 702, a second mixer 703, a local oscillator 704 that may include a voltage controlled oscillator, and a buffer 705. A processor may control the local oscillator 704 to generate a carrier signal. The radio communication circuit 700 may further include a digital front end 706 and low pass filters 707, 708 coupled to the modulator 701. The modulator 701 may be coupled to a quadrature generator 709 that is configured to provide an output signal to a power amplifier 710. The remaining port of the quadrature generator 709 may be coupled to a resistor 711 that is coupled to the ground.

The digital front end 706 may provide a first baseband signal including an in-phase component to the first mixer 702 via the low pass filter 707. The digital front end 706 may provide a second baseband signal including a quadrature component to the second mixer 703 via the low pass filter 708. The first mixer 702 and the second mixer 703 may also receive the carrier signal which the local oscillator 704 generates. Accordingly, the first mixer 702 may multiply the first baseband signal with the carrier signal to provide a first modulated signal. The carrier signal may include a sinusoidal signal with an amplitude and a frequency. The second mixer 703 may multiply the second baseband signal with the carrier signal which may include the sinusoidal signal with the same amplitude and the same frequency to provide a second modulated signal.

The first mixer 702 may output the first modulated signal oscillating at the carrier frequency, and the second mixer 703 may output the second modulated signal oscillating at the same carrier frequency without a phase difference between the first modulated signal and the second modulated signal. In other words, the first modulated signal and the second modulated signal may be in phase. In other words, the first modulated signal may include a sinusoidal signal oscillating at the carrier frequency, and the second modulated signal may include a sinusoidal signal oscillating at the carrier frequency which has zero phase difference relative to the first modulated signal.

The quadrature generator 709 may receive the first modulated signal as the first signal and the second modulated signal as the second signal. The quadrature generator 709 may be configured to provide a predefined phase difference between the first signal and the second signal. The quadrature generator 709 may provide the predefined phase difference of 90 degrees between the first signal and the second signal. Accordingly, the quadrature generator 709 may obtain an in-phase component of the output signal from the first signal based on the in-phase component provided by the first baseband signal, and to obtain a quadrature component of the output signal from the second signal based on the quadrature component provided by the second baseband signal.

The quadrature generator 709 may include a quadrature coupler including a first port coupled to a first signal path that is coupled to the modulator 701 to receive the first signal, a second port coupled to a second signal path that is coupled to the modulator 701 to receive the second signal, a third port to provide an output signal, and a fourth port coupled to the resistor 711 to terminate the quadrature coupler with a load. Accordingly, the quadrature coupler may be configured to isolate the impedance variance in any one of its ports from other ports. Further, the quadrature coupler may combine the in-phase component of the radio communication output signal and the quadrature component of the output signal to obtain the output signal. The quadrature coupler may provide the output signal from the third port.

The power amplifier 710 may receive the output signal, and amplify the output signal to obtain an amplified output signal to be provided to an antenna port and/or an antenna. The antenna may transmit the radio communication signal which may include the amplified output signal.

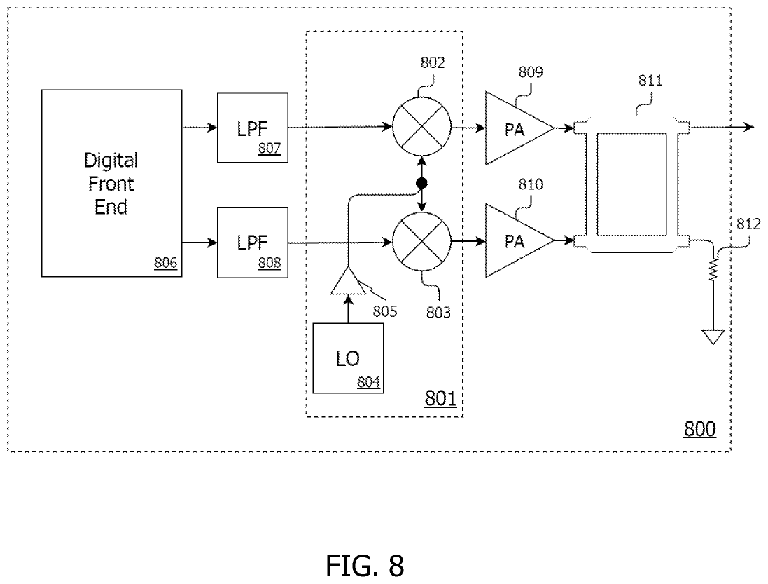

FIG. 8 shows schematically an example of a radio communication circuit. Aspects that are provided in FIG. 6 and FIG. 7 may also apply to FIG. 8, e.g. in relation to the radio communication circuit 800. The radio communication circuit 800 may include a modulator 801. The modulator 801 may include a first mixer 802, a second mixer 803, a local oscillator 804 that may include a voltage controlled oscillator, and a buffer 805. A processor may control the local oscillator 804 to generate a carrier signal. The modulator 801 may be coupled to a digital front end 806 and/or a processor, and low pass filters 807, 808 to receive a first baseband signal and a second baseband signal. The radio communication circuit 800 may further include the digital front end 806 and the low pass filters 807, 808.

The modulator 801 may be coupled to a first power amplifier 809 and a second power amplifier 810. The first power amplifier 809 and the second power amplifier 810 may be coupled to a quadrature generator 811 that is configured to receive a first signal from the first power amplifier 809, and receive a second signal from the second power amplifier 810. The quadrature generator 811 may be further configured to provide an output signal. The remaining port of the quadrature generator 811 may be coupled to a resistor 812 that is coupled to the ground.

The digital front end 806 may provide a first baseband signal including an in-phase component to the first mixer 802 over the low pass filter 807. The digital front end 806 may provide a second baseband signal including a quadrature component to the second mixer 803 over the low pass filter 808. The first mixer 802 and the second mixer 803 may also receive the carrier signal which the local oscillator 804 generates. Accordingly, the first mixer 802 may mix the first baseband signal with the carrier signal to provide a first modulated signal. The carrier signal may include a sinusoidal signal with an amplitude and a frequency. The second mixer 803 may multiply the second baseband signal with the carrier signal which may include the sinusoidal signal with the same amplitude and the same frequency to provide a second modulated signal.

The first mixer 802 may output the first modulated signal oscillating at the carrier frequency, and the second mixer 803 may output the second modulated signal oscillating at the same carrier frequency without a phase difference relative to the first modulated signal. In other words, the first modulated signal and the second modulated signal may be in phase. In other words, the first modulated signal may include a sinusoidal signal oscillating at the carrier frequency, and the second modulated signal may include a sinusoidal signal oscillating at the carrier frequency which has zero phase difference relative to the first modulated signal.

The modulator 801 may be coupled to the first power amplifier 809 to provide the first modulated signal. The first power amplifier 809 receives the first modulated signal to amplify the first modulated signal, and the first power amplifier 809 may output the amplified first modulated signal. The modulator 801 may also be coupled to the second power amplifier 810 to provide the second modulated signal. The second power amplifier 810 receives the second modulated signal to amplify the second modulated signal, and the second power amplifier 810 may output the amplified second modulated signal.

The first power amplifier 809 may be coupled to a first port of the quadrature generator 811 to provide the amplified first modulated signal to the quadrature generator 811. Similarly, the second power amplifier 810 may be coupled to a second port of the quadrature generator 811 to provide the amplified second modulated signal to the quadrature generator 811.

The quadrature generator 811 may receive the amplified first modulated signal as the first signal and the amplified second modulated signal as the second signal. The first signal may include a sinusoidal signal based on the first baseband signal oscillating at the carrier frequency and the second signal may include a sinusoidal signal based on the second baseband signal oscillating the carrier frequency. The first signal and the second signal may be in phase, i.e. there is no phase difference between the first signal and the second signal. The quadrature generator 811 may be configured to provide a predefined phase difference between the first signal and the second signal.

The quadrature generator 811 may provide the predefined phase difference of 90 degrees between the first signal and the second signal. Accordingly, the quadrature generator 811 may obtain an in-phase component of the output signal from the first signal based on the in-phase component provided by the first baseband signal. Further, the quadrature generator 811 may obtain a quadrature component of the output signal from the second signal based on the quadrature component provided by the second baseband signal.

The quadrature generator 811 may include a quadrature coupler, e.g. a 90 degree hybrid, including the first port coupled to a first signal path that is coupled to the first power amplifier 809 to receive the first signal, the second port coupled to a second signal path that is coupled to the second power amplifier 810 to receive the second signal, a third port to provide an output signal, and a fourth port coupled to the resistor 812 to terminate the quadrature coupler with a load.

Accordingly, the quadrature coupler may be configured to isolate the impedance variance in any one of its ports from other ports. In other words, the quadrature coupler may provide an isolating combination, such that impedance variation due to large signal at the first port may not affect the impedance provided to the second port. Furthermore, the peak output power may increase via the collective contribution of the first power amplifier 809 and the second power amplifier 810.

Further, the quadrature coupler may combine the first signal and the second signal to obtain the output signal. The quadrature coupler may combine the in-phase component of the output signal which is based on the first modulated signal and the quadrature component of the output signal which is based on the second modulated signal to obtain the output signal. The quadrature coupler may provide the output signal from the third port.

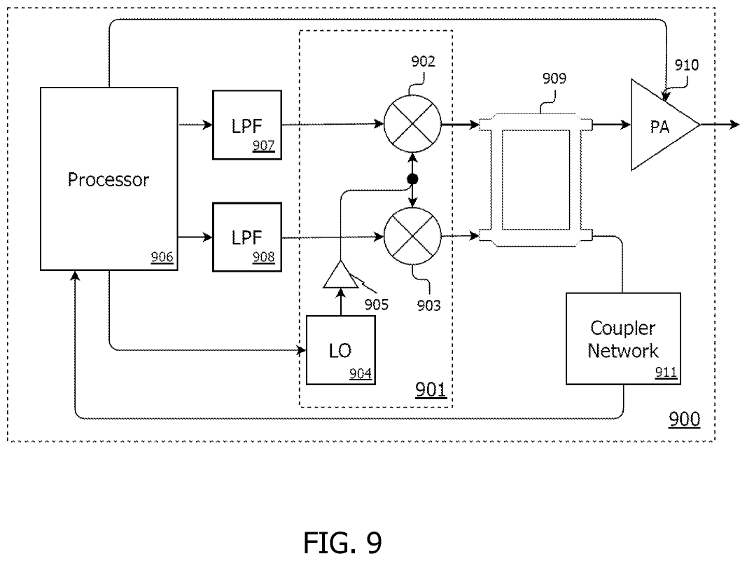

FIG. 9 shows schematically an example of a radio communication circuit. Aspects that are provided in accordance with FIG. 6, FIG. 7, and/or FIG. 8 in this disclosure may also apply to FIG. 9, e.g. in relation to the radio communication circuit 900. The radio communication circuit 900 may include a modulator 901. The modulator 901 may include a first mixer 902, a second mixer 903, a local oscillator 904 that may include a voltage controlled oscillator, and a buffer 905. The radio communication circuit 900 may further include a processor 906 that may control the local oscillator 704 to generate a carrier signal. The processor 906 may include a baseband processor and/or a digital front end. The processor 906 may be coupled to the modulator 901 over low pass filters 907, 908 to provide a first baseband signal and a second baseband signal. The modulator 901 may be coupled to a quadrature generator 909 that is configured to provide an output signal to a power amplifier 910. The remaining port of the quadrature generator 909 may be coupled to a coupler network 911 that is configured to provide a feedback to the processor 906.

The processor 906 may provide the first baseband signal including an in-phase component to the first mixer 902 via the low pass filter 907. The processor 906 may provide the second baseband signal including a quadrature component to the second mixer 903 via the low pass filter 908. The first mixer 902 and the second mixer 903 may also receive the carrier signal which the local oscillator 904 generates based on a control signal provided by the processor 906. Accordingly, the first mixer 902 may mix the first baseband signal with the carrier signal to provide a first modulated signal. The carrier signal may include a sinusoidal signal with an amplitude and a frequency. The second mixer 903 may mix the second baseband signal with the carrier signal which may include the sinusoidal signal with the same amplitude and the same frequency to provide a second modulated signal.

The first mixer 902 may output the first modulated signal oscillating at the carrier frequency, and the second mixer 903 may output the second modulated signal oscillating at the same carrier frequency without a phase difference relative to the first modulated signal. In other words, the first modulated signal and the second modulated signal may be in phase. In other words, the first modulated signal may include a sinusoidal signal oscillating at the carrier frequency, and the second modulated signal may include a sinusoidal signal oscillating at the carrier frequency which has zero phase difference relative to the first modulated signal.

The quadrature generator 909 may receive the first modulated signal as the first signal and the second modulated signal as the second signal. The quadrature generator 909 may be configured to provide a predefined phase difference between the first signal and the second signal. The quadrature generator 909 may provide the predefined phase difference of 90 degrees between the first signal and the second signal. Accordingly, the quadrature generator 909 may obtain an in-phase component of the output signal from the first signal based on the in-phase component provided by the first baseband signal, and to obtain a quadrature component of the output signal from the second signal based on the quadrature component provided by the second baseband signal.

The power amplifier 910 may receive the output signal, and amplify the output signal to obtain an amplified output signal to be provided to an antenna port and/or an antenna. The antenna may transmit the radio communication signal which may include the amplified output signal.

The quadrature generator 909 may include a quadrature coupler. The quadrature generator 909 may include a first port coupled to a first signal path that is coupled to the modulator 901 to receive the first signal, a second port coupled to a second signal path that is coupled to the modulator 901 to receive the second signal, a third port to provide an output signal, and a fourth port. The fourth port may include an isolating port of the quadrature generator 909. The fourth port of the quadrature coupler may be configured to couple a feedback signal based on the output signal of the quadrature generator 909 to the coupler network 911. The quadrature generator 909 may provide a reflection signal of the output signal as the feedback signal. The coupler network 911 may be configured to provide the feedback signal to the processor 906.

The processor 906 may include a signal processing block that is configured to process the feedback signal. The processing of the feedback signal may include measuring the power of the feedback signal, and/or measuring distortion on the feedback signal. The processing of the feedback signal may include measuring the amplitude and/or frequency and/or phase of signals which the feedback signal includes. The processing of the feedback signal may include measuring voltage standing wave ratio (VSWR) between the radio communication circuit 900 and an antenna coupled to the radio communication circuit 900. Accordingly, the processor 906 may determine whether the processor 906 should perform an adjustment at a parameter for the radio communication circuit 900 based on the feedback signal.

The processor 906 may receive the feedback signal, and adjust the amplitude of at least one of the first baseband signal and/or the second baseband signal based on the feedback signal. The processor 906 may adjust the amplitude of at least one of the first baseband signal and/or the second baseband signal based on the feedback signal to compensate for the IQ imbalance that may occur based on the first baseband signal and/or the second baseband signal. The processor 906 may be coupled to a memory to receive at least one parameter to determine an adjustment of the amplitude of at least one of the first baseband signal and/or the second baseband signal based on information in the memory. The memory may include a table indicating the adjustment of the amplitude based on the feedback signal.

The processor 906 may receive the feedback signal, and adjust the carrier signal(s) provided by the local oscillator 904 and/or the buffer 905. The processor 906 may adjust the amplitude of the carrier signal based on the feedback signal. The processor 906 may be coupled to a memory to receive at least one parameter to determine an adjustment of the amplitude of the carrier signal based on information in the memory. The memory may store a table indicating the adjustment of the amplitude based on the feedback signal.

The processor 906 may receive the feedback signal and adjust a parameter of the power amplifier 910. The processor 906 may adjust a gain of the power amplifier 910 which the power amplifier 910 is configured to amplify the output signal. The processor 906 may adjust the gain of the power amplifier 910 based on the feedback signal to adjust the transmission power. The processor 906 may be coupled to a memory to receive at least one parameter to determine an adjustment of the parameter of the power amplifier 910 according to the feedback signal based on information in the memory. The memory may include a table indicating the adjustment of the parameter of the power amplifier 910 based on the feedback signal.

The processor 906 may be coupled to a plurality of radio communication circuits including a second radio communication circuit that is configured to transmit a second radio communication signal. The processor 906 may receive the feedback signal from the coupler network 911, and control at least one of the parameters that may include the amplitude of baseband signals, and/or the amplitude and/or phase of the carrier signal, and/or at least one of parameters of a power amplifier of the second radio communication circuit.

A radio transmitter may include a processor configured to provide a digital communication signal to a digital to analog converter, and the digital to analog converter may provide baseband signals to a radio communication circuit in accordance with various aspects of this disclosure. The processor of the radio transmitter may be configured to receive a feedback signal from the radio communication circuit.

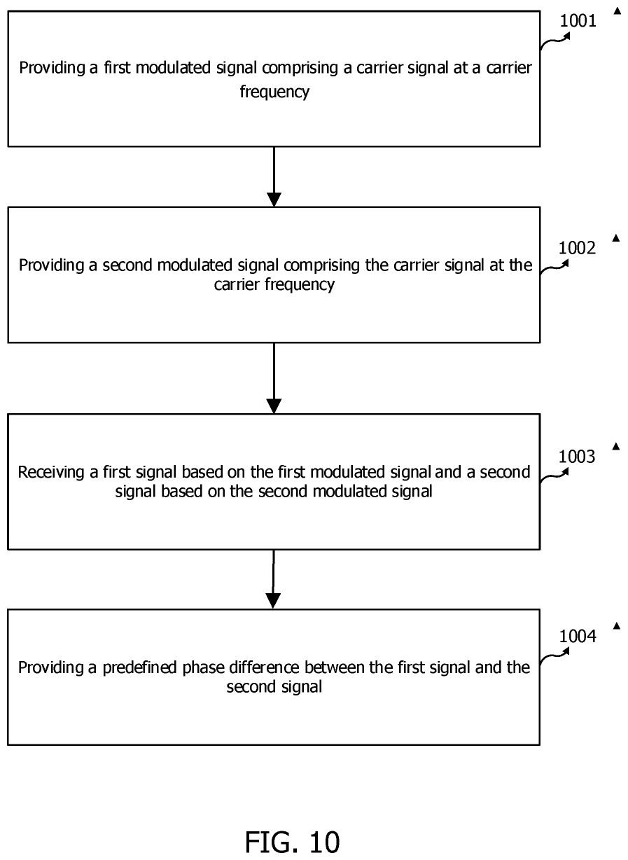

FIG. 10 shows schematically an example of a method. The method may include providing a first modulated signal including a carrier signal at a carrier frequency, and a second modulated signal including the carrier signal at the carrier frequency; and receiving a first signal based on the first modulated signal and a second signal based on the second modulated signal, and providing a predefined phase difference between the first signal and the second signal.

The following examples pertain to further aspects of this disclosure.

Example 1 includes a subject matter of a radio communication circuit. The subject matter of example 1 may include a modulator configured to provide a first modulated signal including a carrier signal at a carrier frequency, and a second modulated signal including the carrier signal at the carrier frequency; a phase shift generator configured to receive a first signal based on the first modulated signal and a second signal based on the second modulated signal, and provide a predefined phase difference between the first signal and the second signal.

In example 2, the subject matter of example 1, can optionally include that the modulator is coupled to a digital front-end and a digital to analog converter to receive a first baseband signal and a second baseband signal. In example 3, the subject matter of example 1, can optionally include that the modulator is coupled to a processor to receive a first baseband signal and a second baseband signal. In example 4, the subject matter of any one of examples 2 to 3, can optionally include that the first baseband signal includes an in-phase signal, and the second baseband signal includes a quadrature signal. In example 5, the subject matter of any one of examples 1 to 4, further including at least one low pass filter coupled to the modulator, can optionally include that the at least one low pass filter is configured to filter the first baseband signal and the second baseband signal.

In example 6, the subject matter of any one of examples 1 to 5, can optionally include that the modulator includes a local oscillator configured to provide the carrier signal at the carrier frequency. In example 7, the subject matter of example 6, further including a buffer coupled to the local oscillator. In example 8, the radio communication circuit of examples 6 or 7, can optionally include that the local oscillator includes a buffer.

In example 9, the subject matter of any one of examples 1 to 8, further including: a first power amplifier configured to amplify the first modulated signal and provide the first signal; and a second power amplifier configured to amplify the second modulated signal and provide the second signal. In example 10, the subject matter of example 9, can optionally include that the first power amplifier is configured to amplify the first modulated signal with a first gain, and can optionally include that the second power amplifier is configured to amplify the second modulated signal with a second gain.

In example 11, the subject matter of example 10, can optionally include that the first gain is controlled by a first control signal provided by a processor, and can optionally include that the second gain is controlled by a second control signal provided by the processor. In example 12, the subject matter of any one of examples 1 to 11, can optionally include that the modulator includes a first mixer configured to receive the first baseband signal and mix the first baseband signal with the carrier signal at the carrier frequency, and a second mixer configured to receive the second baseband signal and mix the second baseband signal with the carrier signal at the carrier frequency.

In example 13, the subject matter of any one of examples 1 to 12, can optionally include that the modulator is configured to provide a first output signal based on the first baseband signal and a second output signal based on the second baseband signal, can optionally include that the first output signal and the second output signal are in phase. In example 14, the subject matter of any one of examples 1 to 13, can optionally include that the first signal includes the first modulated signal, and the second signal includes the second modulated signal.

In example 15, the subject matter of any one of examples 1 to 14, further may include: a power amplifier configured to amplify the output signal and provide an amplified output signal. In example 16, the subject matter of any one of examples 1 to 15, further may include: an antenna configured to transmit the output signal. In example 17, the subject matter of any one of examples 1 to 16, can optionally include that the modulator is configured to receive the first baseband signal may include an in-phase component, and the second baseband signal may include a quadrature component; and can optionally include that the phase shift generator includes a quadrature generator to provide the predefined phase difference of 90 degrees.

In example 18, the subject matter of example 17, can optionally include that the quadrature generator includes a passive quadrature generator. In example 19, the subject matter of example 17 or 18, can optionally include that the quadrature generator includes at least one of the following: a branch-line coupler, a 90-degree hybrid, a quadrature coupler, a quadrature hybrid. In example 20, the subject matter of any one of examples 17 to 19, can optionally include that the quadrature generator includes a branch-line coupler; and can optionally include that the subject matter includes a set of quarter wavelength transmission lines. In example 21, the subject matter of any one of examples 17 to 20, can optionally include that the quadrature generator includes a 90-degree hybrid may include lumped inductors.

In example 22, the subject matter of any one of examples 17 to 21, can optionally include that the quadrature generator is configured to output an output signal may include the first signal, and the second signal which is delayed by 90 degrees relative to the first signal. In example 23, the subject matter of any one of examples 17 to 22, can optionally include that the quadrature generator is configured to act as an isolating combiner to isolate an impedance variance in any one of the first port, the second port, the third port, and/or the fourth port from other ports of the first port, the second port, the third port, and the fourth port.

In example 24, the subject matter of any one of examples 17 to 23, can optionally include that the quadrature generator includes a quadrature coupler may include a first port coupled to a first signal path to receive the first signal, and a second port coupled to a second signal path to receive the second signal, a third port configured to output an output signal. In example 25, the subject matter of any one of examples 17 to 24, can optionally include that the quadrature generator is configured to provide a feedback signal.

In example 26, the subject matter of example 25, can optionally include that the feedback signal includes a reflection signal indicating the output signal of the quadrature generator. In example 27, the subject matter of example 24, can optionally include that the processor is configured to receive the feedback signal.

In example 28, the subject matter includes a radio transmitter. The radio transmitter may include a modulator configured to provide a first modulated signal may include a carrier signal at a carrier frequency, and a second modulated signal may include the carrier signal at the carrier frequency; a phase shift generator configured to receive a first signal based on the first modulated signal and a second signal based on the second modulated signal, and provide a predefined phase difference between the first signal and the second signal; a processor configured to provide a digital communication signal to the radio communication circuit. In example 29, the radio transmitter of example 28, can optionally include that the processor is configured to receive a feedback signal from the phase shift generator.

In example 30, the subject matter is a radio communication circuit. The subject matter may include: a modulator for providing a first modulated signal may include a carrier signal at a carrier frequency, and a second modulated signal may include the carrier signal at the carrier frequency; a phase shifter configured to receive a first signal based on the first modulated signal and a second signal based on the second modulated signal, and provide a predefined phase difference between the first signal and the second signal.

In example 31, the subject matter of example 30, can optionally include that the modulator is suitable for receiving a first baseband signal may include an in-phase component, and a second baseband signal may include a quadrature component; and can optionally include that the phase shift generator includes a quadrature generator for providing the predefined phase difference of 90 degrees.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted. It should be noted that certain components may be omitted for the sake of simplicity. It should be noted that nodes (dots) are provided to identify the circuit line intersections in the drawings including electronic circuit diagrams.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

As used herein, a signal that is “indicative of” or “indicating” a value or other information may be a digital or analog signal that encodes or otherwise, communicates the value or other information in a manner that can be decoded by and/or cause a responsive action in a component receiving the signal. The signal may be stored or buffered in computer-readable storage medium prior to its receipt by the receiving component and the receiving component may retrieve the signal from the storage medium. Further, a “value” that is “indicative of” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The terms “one or more processors” is intended to refer to a processor or a controller. The one or more processors may include one processor or a plurality of processors. The terms are simply used as an alternative to the “processor” or “controller”.

As utilized herein, terms “module”, “component,” “system,” “circuit,” “element,” “slice,” “circuit,” and the like are intended to refer to a set of one or more electronic components, a computer-related entity, hardware, software (e.g., in execution), and/or firmware. For example, circuit or a similar term can be a processor, a process running on a processor, a controller, an object, an executable program, a storage device, and/or a computer with a processing device. By way of illustration, an application running on a server and the server can also be circuit. One or more circuits can reside within the same circuit, and circuit can be localized on one computer and/or distributed between two or more computers. A set of elements or a set of other circuits can be described herein, in which the term “set” can be interpreted as “one or more.”

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D Points, among others, or any combination thereof. Registers, shift registers, processor registers, data buffers, among others, are also embraced herein by the term memory. The term “software” refers to any type of executable instruction, including firmware.

The term “antenna”, as used herein, may include any suitable configuration, structure and/or arrangement of one or more antenna elements, components, units, assemblies and/or arrays. The antenna may implement transmit and receive functionalities using separate transmit and receive antenna elements. The antenna may implement transmit and receive functionalities using common and/or integrated transmit/receive elements. The antenna may include, for example, a phased array antenna, a single element antenna, a set of switched beam antennas, and/or the like.

It will be understood that when an element is referred to as being “connected” or “coupled” to another element, it can be physically connected or coupled to the other element such that current and/or electromagnetic radiation (e.g., a signal) can flow along a conductive path formed by the elements. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “provided” to an element, the voltage, current, or signal may be conducted to the element by way of a physical connection or by way of capacitive, electro-magnetic, or inductive coupling that does not involve a physical connection.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Spatial Divisional Multiple Access (SDMA), Time-Division Multiplexing (TDM), Time-Division Multiple Access (TDMA), Multi-User MIMO (MU-MIMO), General Packet Radio Service (GPRS), extended GPRS (EGPRS), Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth (BT), Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other aspects may be used in various other devices, systems and/or networks.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN, and the like.

Some aspects may be used in conjunction with a wireless communication network communicating over a frequency band of 2.4 GHz, 5 GHz, and/or 6-7 GHz. However, other aspects may be implemented utilizing any other suitable wireless communication frequency bands, for example, an Extremely High Frequency (EHF) band (the millimeter wave (mmWave) frequency band), e.g., a frequency band within the frequency band of between 20 GHz and 300 GHz, a WLAN frequency band, a WPAN frequency band, and the like.

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A radio communication circuit comprising
a modulator configured to provide a first modulated signal comprising a carrier signal at a carrier frequency, and a second modulated signal comprising the carrier signal at the carrier frequency;
a phase shift generator configured to:
receive a first signal based on the first modulated signal and a second signal based on the second modulated signal, and
provide a predefined phase difference between the first signal and the second signal.

2. The radio communication circuit of claim 1,
wherein the modulator is coupled to a digital front-end and a digital to analog converter to receive the first modulated signal and the second modulated signal.

3. The radio communication circuit of claim 1,
wherein the modulator comprises a local oscillator configured to provide the carrier signal at the carrier frequency.

4. The radio communication circuit of claim 1, further comprising:
a first power amplifier configured to amplify the first modulated signal and provide the first signal; and
a second power amplifier configured to amplify the second modulated signal and provide the second signal.

5. The radio communication circuit of claim 1,
wherein the phase shift generator is further configured to combine the power of the first signal and the second signal.

6. The radio communication circuit of claim 1,
wherein the modulator is configured to receive a first baseband signal comprising an in-phase component, and a second baseband signal comprising a quadrature component; and
wherein the phase shift generator comprises a quadrature generator to provide a predefined phase difference of 90 degrees.

7. The radio communication circuit of claim 6,
wherein the modulator comprises a first mixer configured to receive the first baseband signal and to mix the first baseband signal with the carrier signal at the carrier frequency, and a second mixer configured to receive the second baseband signal and to mix the second baseband signal with the carrier signal at the carrier frequency.

8. The radio communication circuit of claim 6,
wherein the quadrature generator comprises a branch-line coupler; and
wherein the radio communication circuit comprises a set of quarter wavelength transmission lines.

9. The radio communication circuit of claim 6,
wherein the quadrature generator comprises a 90-degree hybrid comprising lumped inductors.

10. The radio communication circuit of claim 6,
wherein the first signal comprises the first modulated signal, and the second signal comprises the second modulated signal; and
wherein the quadrature generator is configured to output an output signal comprising the first signal, and the second signal which is delayed by 90 degrees relative to the first signal.

11. The radio communication circuit of claim 10, further comprising:
a power amplifier configured to amplify the output signal and provide an amplified output signal.

12. The radio communication circuit of claim 10, further comprising:
an antenna configured to transmit the output signal.

13. The radio communication circuit of claim 6,
wherein the quadrature generator comprises a quadrature coupler comprising a first port coupled to a first signal path to receive the first signal, and a second port coupled to a second signal path to receive the second signal, a third port configured to output an output signal.

14. The radio communication circuit of claim 13,
wherein the quadrature coupler comprises a fourth port configured to couple to a coupler network, and the quadrature coupler is configured to provide a feedback signal from the fourth port to the coupler network.

15. The radio communication circuit of claim 14,
wherein the feedback signal comprises a reflection signal based on the output signal.

16. The radio communication circuit of claim 15,
wherein the quadrature coupler is configured to act as an isolating combiner to isolate an impedance variance in any one of the first port, the second port, the third port, and/or the fourth port from other ports of the first port, the second port, the third port, and the fourth port.

17. A radio transmitter comprising:
a radio communication circuit comprising
a modulator configured to provide a first modulated signal comprising a carrier signal at a carrier frequency, and a second modulated signal comprising the carrier signal at the carrier frequency;
a phase shift generator configured to
receive a first signal based on the first modulated signal and a second signal based on the second modulated signal, and
provide a predefined phase difference between the first signal and the second signal;
a processor configured to provide a digital communication signal to the radio communication circuit.

18. The radio transmitter of claim 17,
wherein the processor is configured to receive a feedback signal from the phase shift generator.

19. A radio communication circuit comprising:
a modulator for providing a first modulated signal comprising a carrier signal at a carrier frequency, and a second modulated signal comprising the carrier signal at the carrier frequency;
a phase shifter configured to
receive a first signal based on the first modulated signal and a second signal based on the second modulated signal, and
provide a predefined phase difference between the first signal and the second signal.

20. The radio communication circuit of claim 19,
wherein the modulator is suitable for receiving a first baseband signal comprising an in-phase component, and a second baseband signal comprising a quadrature component; and
wherein the phase shift generator comprises a quadrature generator for providing the predefined phase difference of 90 degrees.
